(19) United States
(12) Patent Application Publication
(10) Pub. No.: US 2023/0024244 A1
(43) Pub. Date: Jan. 26, 2023

(54) METHOD FOR OPERATING A HEAT EXCHANGER, AND ENERGY STORE HEAT EXCHANGE SYSTEM

(71) Applicant: Lisa Dräxlmaier GmbH, Vilsbiburg (DE)

(72) Inventors: Peter Faltermeier, Landshut (DE); Michael Steckel, Vilsbiburg (DE)

(21) Appl. No.: 17/620,906

(22) PCT Filed: Apr. 27, 2020
(86) PCT No.: PCT/EP2020/061601

§ 371 Date: Oct. 9, 2022

(30) Foreign Application Priority Data
Jun. 18, 2019 (DE) 10 2019 116 462.1

(51) Int. Cl. F28F 27/02; H01M 10/625; H01M 10/613; H01M 10/6551

(52) U.S. Cl. CPC F28F 27/02; H01M 10/625; H01M 10/613; H01M 10/6551

(57) ABSTRACT

Disclosed is a method for operating a heat exchanger and an energy store heat exchange system with an energy store including multiple electrochemical cells for providing electrical energy, with a flow duct for providing the cells with a flow of a heat-exchange medium in a flow direction, wherein the cells are arranged in series in the flow direction, wherein the cells each have a heat-exchange surface around which the heat-exchange medium can be made to flow and through which heat can be exchanged between the heat-exchanging medium and the cell, wherein a first (in the flow direction (S)) cell has a first heat-exchange surface, wherein a second cell, arranged downstream of the first cell, has a second heat-exchange surface, the second heat-exchange surface being larger than the first heat-exchange surface, and with an open- and/or closed-loop control unit for setting the volumetric flow.

### CROSS REFERENCE TO RELATED APPLICATIONS

This application is a national phase application of international patent application PCT/EP2020/061601, filed Apr. 27, 2020, which claims priority to German patent application DE 102019116462,1, filed Jun. 18, 2019, the content of both of which is hereby incorporated by reference.

### BACKGROUND OF THE INVENTION

The present disclosure relates to a method of operating a heat exchanger for an energy storage device comprising a plurality of electrochemical cells, and to an energy storage heat exchanger system.

In the case of electrochemical energy storage systems, for example batteries, a providing the desired voltage level by connecting individual electrochemical cells in series. A plurality of cells may be grouped into individual modules. The desired voltage is then generated by stringing together corresponding modules with a corresponding number of cells.

The typical field of application of such energy storage devices is electromobility, in particular electrically powered vehicles, but their use is not limited to this. The electric motor used to drive a vehicle consumes a high amount of electrical power during acceleration, which is provided by the energy storage device or the electrochemical cells of the energy storage device.

When energy is drawn from the energy storage device or from the electrochemical cells, the sum of all resistances (e.g., internal cell resistance, contact resistance, etc.), depending on the current intensity, results in power loss in the cells, which is converted into heat. The power loss heats up the Energy storage or the cells, so that without a removal of this heat energy the energy storage or cells of the energy storage would overheat.

Thus, a cooling or a heat exchanger for an energy storage system to prevent overheating. In this context, heat exchangers are predominantly used which are integrated into the existing heat exchanger circuit, in particular cooling circuit, of a vehicle. These are used for example operated with a water/glycol mixture. In order to avoid short circuits, the water/glycol mixture, which is electrically conductive, must not come into contact with the electrochemical cells, in particular their electrical contacts; the same applies to the heat sink through which the water/glycol mixture flows, which is usually made of metal to improve heat conduction.

However, if a non-electrically conductive medium is used for the heat exchange process, in particular cooling, e.g., a transformer, the cells can come into direct contact with this medium.

This heat-exchanging medium flows around the heated cells, exchanges heat, in particular absorbs heat from the cells, and flows around the cells. In practice, this is a continuous process. However, such processes result in the cells around which the heat-exchanging medium flows having different temperatures, since the medium heats up as it flows from cell to cell, reducing the heat transferred to the medium from cell to cell.

However, a higher temperature causes an electrochemical cell to age faster, so that the cells of the energy storage device age differently and, depending on the failure of the oldest cells, the voltage level of the energy storage device changes until individual cells, modules or the entire energy storage device must be replaced.

### BRIEF SUMMARY OF THE INVENTION

It is therefore a task of the disclosure, using means which are as simple as possible in terms of construction, to develop a method, a control and/or regulating device, and an energy storage system which reduces the probability of failure of an energy storage system.

The problem is solved by the objects of the independent claims. Advantageous further embodiments of the invention are described in the dependent claims, in the description and in particular, the independent claims of one claim category can also be further developed analogously to the dependent claims of another claim category. Further advantageous embodiments and further embodiments of the invention result from the sub-claims as well as from the Description with reference to the figures.

A method according to the invention is provided as a method for operating a heat exchanger for an energy store comprising a plurality of electrochemical cells, wherein the cells are successively surrounded in a flow direction by a heat-exchanging medium for heat exchange, wherein the cells each have a heat exchange surface, via which the heat exchange between the medium and the respective cell takes place, wherein a first cell in the flow direction exchanges the heat with the heat-exchanging medium via a first heat exchange surface, and a second cell arranged downstream of the first cell exchanges heat by means of a second heat exchange surface which is larger than the first heat exchange surface, wherein a volume flow of the heat exchange medium is set in such a way, a temperature difference between a temperature of the first cell and a temperature of the second cells is reduced, in particular minimized, for a selected operating point of the cells.

The method described makes it possible to equalize the temperature-related aging of the cells by reducing the temperature differences between the cells. As a rule, the cell around which the heat-exchanging medium first flows in the direction of flow and the cell around which the same heat-exchanging medium last flows in the direction of flow have the same temperature differences. By increasing the heat exchange areas of the cells in the direction of current flow, the temperature difference between these cells can be reduced. In this way, the temperature-related aging of the cells can be equalized and there is no failure of cells due to premature aging. The process already unfolds effect if the heat exchange surface is enlarged such that a first heat exchange surface of a first cell is enlarged compared to a second heat exchange surface of a second cell arranged downstream. That is to say, there are cells with heat exchange surfaces of different sizes in the direction of flow, a smaller heat exchange surface being provided downstream than upstream.

The cells can also be designed as a group of cells, each with the same heat exchange surface, whereby the heat exchange surface increases for the groups of cells in the direction of flow. In a particularly advantageous embodiment, the increase in the heat exchange surface takes place successively for cells arranged in the direction of flow. In other words, the heat exchange surface increases from each cell to the next adjacent cell in the direction of flow, which are flowed around in the direction of flow by the same heat-exchanging medium flow, in particular coolant flow. By the same medium flow, it is understood that between the flow of the individual cells no significant heat exchange or on absorption of the media flow takes place, which is not caused by the heat exchange or—the heat absorption of the circulating cells.

It can also be used from the first cell in the direction of flow for each further cell in the direction of flow.

In addition, an increase in the size of the heat exchange surface can be provided for the cell following in the direction of current flow.

A heat exchanger is a device which serves to exchange heat. For this purpose, flowable materials can be used as a heat-exchanging medium, in particular gas or liquids which are not electrically conductive.

Such a process can be used for cooling and heating the cells. However, the main focus is often on cooling the cells, especially if a corresponding energy storage system is used to drive vehicles.

However, in cool ambient conditions, heating of the cells may also be desirable in order to increase the capacity of the energy storage device even at low temperatures. outside temperatures. This can lead to a cell temperature that has a detrimental effect on its energy storage or energy output capacity. This can be prevented by heating the cells.

Several cells are considered to be at least two cells, but in particular a plurality of cells which are arranged one behind the other in the direction of current flow. Advantageously, 7 to 15, in particular 10, cells are connected in the direction of current flow. arranged one behind the other, around which the same heat-exchanging medium flow, in particular coolant flow, flows.

The boundary of the cells can serve as heat exchange surfaces if they have a have sufficiently high thermal conductivity, such as being metallic. Separate structures may also be provided on the cell to allow heat exchange, such as separate cooling fins or cooling surfaces, such as cooling fins, projecting into the flow of the heat-exchanging medium.

Advantageously, the first cell used is the first cell in the direction of flow and the second cell used is the last cell in the direction of flow. In particular, the last cell is the cell in the direction of flow before the heat-exchanging medium is subjected to an inverse heat-exchange process compared with the heat-exchange process which has taken place in the energy store. If the medium is heated in the energy store, an inverse heat exchange process would take place, heat exchange process a cooling of the medium and vice versa.

In one embodiment of the method, a first temperature of the medium is sensed at a first position and a second temperature is sensed at a second, downstream position, and a second temperature is sensed at a second, upstream position, and a second temperature is sensed at a second, downstream position, and a second temperature is sensed at a second, upstream position, based on conditions, in particular the present cell flow, the volume flow is adjusted in such a way that the temperature difference of these cells is reduced, in particular minimized.

Advantageously, the first position is before the position of the first cell in the direction of current flow and the second position is arranged behind the last cell in the direction of flow, which is flowed around by the same heat exchanging medium flow. In addition to the first and second positions, further temperatures can be detected at other positions, preferably at positions arranged between the first and second positions his can be provided, in particular, if the first position in front of the first cell and the second position behind the last cell which is exposed to the same heat-exchanging medium is arranged. The temperature is preferably detected by means of corresponding temperature sensors.

Advantageously, the volume flow is adjusted by means of a corresponding, previously determined characteristic curve for the energy storage system or a corresponding part of the energy storage system, such as a module having a plurality of cells, which is irradiated or flowed through by the same media flow in a heat-exchanging manner. The characteristic curve field covers various operating points, in particular cell currents, which can occur during operation of the energy store. The operating points or cell currents correlate with the heating of the respective cell. In addition, the characteristic curve field preferably comprises the temperature on the input side and on the output side of the heat-exchanging medium and indicates which volume flow is required under such conditions in order to minimize the temperature spread over the cells. On the basis of said characteristic curve field, which can be stored in a corresponding control device, the volume flow of the heat-exchanging medium can be adjusted in such a way that: the temperature difference of the cells between the first and the second position of the temperature measurement of the medium flow is as low as possible.

A maximum temperature difference between the first and the second position of arranged cells can be determined and, if necessary, output, for example on the basis of the current operating point and the detected temperatures of the medium. However, this is not absolutely necessary for setting the volume flow.

If the operating point changes, in that more or less power is called up from the cell than before, or if the temperatures of the medium change at the first or second position, then the volume flow can be readjusted accordingly.

In a further advantageous embodiment of the method, a first temperature of a first cell arranged in the direction of flow and a second temperature for a second cell arranged downstream are detected or determined, the volumetric flow being set in such a way that the difference between the first temperature and the second temperature is reduced. A temperature of the first and second cells may be calculated based on the cell current and the resistances to be taken into account, as well as any other heat propagation conditions present in the cell. However, a temperature sensor may also be provided on the cells, particularly in the region of or at the heat exchange surfaces.

Since the temperature of preferably the first cell in the direction of flow and the last cell in the direction of flow is detected, the temperature difference between the two cells is known and a volume flow can be set in such a way that this temperature difference is reduced. In this way, a control loop can be advantageously established, which dynamically adjusts the volume flow depending on the actual temperature spread or temperature difference and minimizes this temperature difference. In principle, more than two cells, and possibly all cells around which the same heat-exchanging medium flows, can be equipped with a corresponding temperature sensor. The recorded values are preferably supplied to a corresponding control and/or regulating device.

In this respect, it is advantageous if the volume flow is controlled and/or regulated by a control and/or regulating device. This makes it possible that unfavorable temperature differences are dynamically reduced or minimized in a timely manner.

A control and/or regulating device according to the invention is operatively connected to a device for adjusting the volume flow of a heat-exchanging medium, the control and/or regulating device comprising a machine-readable program code which comprises open-loop and/or closed-loop control commands which, when executed, cause the open-loop and/or closed-loop control device to carry out the method according to any one of claims 1 to 5. The control and/or regulating device can additionally be operatively connected to a temperature control device for the heat-exchanging medium, so that the control and/or regulating device not only but can also influence the temperature of the heat-exchanging medium in such a way that the temperature difference of the cells is reduced or minimized.

An energy storage heat exchange system according to the invention comprises an energy storage device, which comprises a plurality of electrochemical cells to provide electrical energy, having a flow channel for flowing a flow of a heat-exchanging medium around the cells in the direction of flow, the cells being arranged one behind the other in the direction of flow, the cells each having a heat-exchanging surface around which the medium can flow and through which heat can be exchanged between the medium and the cell, a heat exchanger surface arranged in the direction of flow being arranged around the cells in the direction of flow.

A heat exchanger comprising a first cell having a first heat exchange surface in the direction of flow, a second cell arranged downstream of the first cell having a second heat exchange surface, the second heat exchange surface being larger than the first heat exchange surface, comprising a control and/or regulating device according to claim 6 and a device for adjusting the volume flow, the control and/or regulating device being operatively connected to the device for adjusting the volume flow in such a way that the volume flow can be controlled and/or regulated by the control and regulating device, in particular in such a way that a temperature difference between a first temperature of the first cell and a temperature of the second cell is reduced, in particular minimized.

Such an energy storage heat exchange system can be used to cool and warm the cells.

The boundary of the cells can serve as heat exchange surfaces, especially if they are sufficiently heat-conductive, e.g. made of metal. In this case, the cells may be placed, for example, in a generally thermally insulating enclosure. The enclosure may be used to construct a corresponding module of cells by rigidly mechanically connecting the enclosures together. The housing can be used to build a corresponding module of cells by mechanically rigidly connecting the housings to each other. The housing for a cell has one or more recesses, which are designed such that the heat-exchanging medium can come into contact with the cell at said recesses, so that a heat exchange between medium and cell is possible at these recessed housing points. Through recesses of the housings of different sizes, heat exchange surfaces of different sizes can be provided for cells without the need for the cells themselves to be modified. Separate structures on the cell can also be provided which allow heat to be exchanged, such as separate cooling fins or cooling surfaces which project into the flow of the heat-exchanging medium in order to release heat from the cell or absorb heat for the cell.

In a further advantageous embodiment, the heat exchange surface for cells arranged one behind the other in the direction of flow is successively enlarged. That is, the heat exchange surface from each cell or group of cells to the next cell or group of cells arranged downstream is reduced. This is done in this way for at least 50% of the cells, advantageously for all cells around which the same heat-exchanging medium flow, in particular coolant flow, can flow in the direction of flow.

Further advantageously, the heat exchange surfaces are enlarged downstream from cell to cell and are designed in such a way that, at a predetermined operating point and at a minimum of a maximum temperature difference between the first cell in the direction of flow and the last cell in the direction of flow is reached for a given volume flow with a specific input temperature.

In one embodiment of the energy storage heat exchange system, a first sensor for sensing a temperature of the medium is provided at a first position of the flow channel and at least one second sensor for sensing a temperature of the medium is provided at a second position of the flow channel downstream relative to the first position.

In a flow channel, whereby the temperatures detected by the first and at least second sensor can be fed to the control and/or regulating device. The presence of such temperature sensors allows a conclusion to be drawn about the current state of the system. In particular, the detected temperatures allow the volume flow to be adjusted in such a way that the temperature difference between two cells in the flow channel can be compensated for. flow of media is minimized.

In addition, a condition associated with the current operating point of the cells, for example the cell current, can be fed to the control and/or regulating device so that, on the basis of the operating point of the cell and the temperatures detected, a volume flow of the heat-exchanging medium can be adjusted, with which a temperature difference of the cells can be reduced.

In a further advantageous embodiment of the energy storage heat exchange system, the heat exchanging medium is fed to a power circuit which is connected from a heat exchange circuit for temperature control of a vehicle cabin or an engine. In this way, the circuit is only subject to the parameters of the energy storage heat exchange system and is independent of other heat exchange processes, in particular the desired engine temperature and/or the vehicle cabin temperature. Control and/or control interventions can thus be reduced, since the heat exchange process of the cells is subject to a smaller number of influencing variables. Overall control/regulation is simplified.

### BRIEF DESCRIPTION OF THE DRAWINGS

Further advantages features and details of the various embodiments of this disclosure will become apparent from 11 the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, with departing from the scope of the disclosure.

Advantageous embodiments of the invention are explained below with reference to the accompanying figures, wherein:

FIG. 1 depicts a first side view of an exemplary energy storage heat exchange system,

FIG. 2 depicts a second top view of the energy storage heat exchange system of FIG. 1, and

FIG. 3 depicts a process flow diagram for an exemplary process flow for a method of operating a heat exchanger for an energy storage heat exchanger system according to FIGS. 1 and 2.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C” then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination.

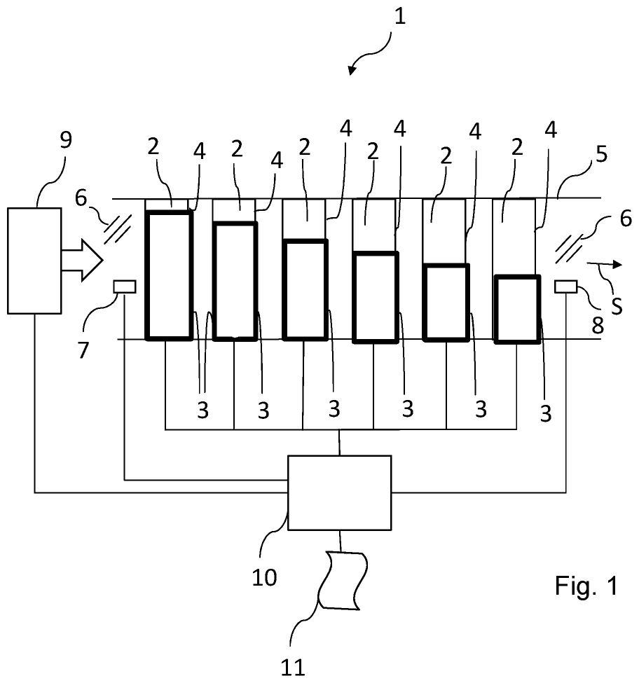

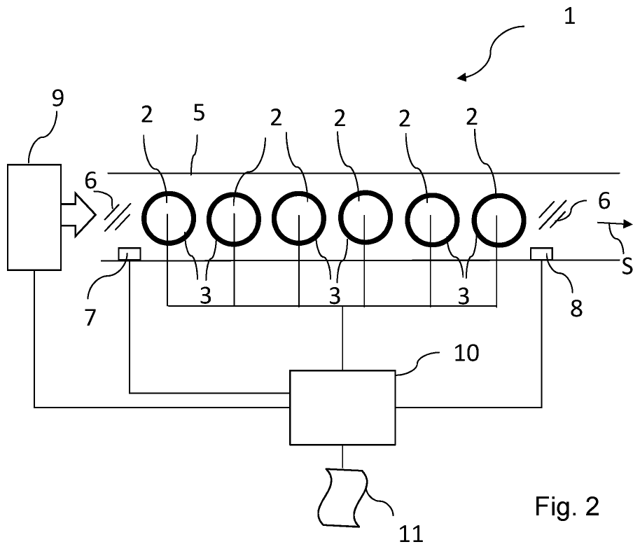

For ease of understanding, in the following description the reference signs are used as follows Retain FIGS. 1 and 2 for reference.

FIG. 1 shows a schematic view of an energy storage heat exchange system 1 comprising an energy storage device comprising a plurality of electrochemical cells 2 for delivering and/or receiving electrical energy. The cells 2 are generally electrically connected in series.

Further cells 2 may be present perpendicular to the plane of the leaf or in the plane of the leaf and may be encompassed by the energy store. Preferably, cells are divided into modules with a certain number of cells 2, e.g. ten, which are distinguishable by the following characterized in that they are energized by the same heat-exchanging medium 6 in a flow direction S in order to conduct heat away from the cells 2. Due to the modular design, an energy storage device with almost any capacity can be constructed.

In the example, the heat-exchanging medium 6 is designed as a non-electrically conductive transformer 1, which is supplied by means of a pump 9 to the flow channel 5, in which the cells 2 are arranged and around which the heat-exchanging medium 6 flows. By means of the pump 9, the volume flow of the medium 6 in the flow channel 5, for example by increasing or decreasing the flow rate of the medium or by changing the pressure with which the medium 6 is acted upon. Advantageously, an incompressible medium 6 is used for this purpose, which simplifies the adjustment of the flow rate. After the heat-exchanging medium 6 has energized the cells 2 and energy has been transferred from the cells 2 to the heat-exchanging medium, this is fed to another heat exchanger. There it releases the absorbed heat back into the environment or another medium in order to avoid permanent heating of the heat-exchanging medium 6. Preferably, the heat-exchanging medium 6 is conducted in a circuit which serves exclusively to cool the cells 2 or the energy store. This heat exchange circuit is thus decoupled from other heat exchange circuits for, for example, the engine or the vehicle cabin.

In FIG. 1, each cell 2 has a different heat exchange surface 4. In this example, the respective cells 2 have good heat conductivity, for example metallic, outer wall. The cells 2 are positioned in housings 3, which structure, for example, a module that can accommodate a certain number of cells 2. The cells 2 are fixed in position in the current channel 5 by the housing 3, each of which accommodates one cell 2.

In the present case, the housings 3 are made of a material which has a poor thermal conductivity compared to the outer wall of the cells 2. For example, the housings are made of plastic. In this embodiment example, the housings 3 enclose the cells 2 in a jacket-like manner in such a way that substantially no heat-exchanging medium 6 can penetrate between the outer wall of the cell 2 and the housing 3. If the cross-section of cells 2 is round, the housing can have a cylindrical shell shape, wherein the inner radius of the cylindrical shell substantially corresponds to the outer radius of cell 2.

The different sizes of the heat exchange surface 4 for the cells 2 arranged one behind the other in the direction of flow S are now realized by the fact that the housings 3 have increasingly larger recesses in the direction of flow S, in which the heat is exchanged.

The outer wall of the cell 2 can come into contact with the heat-exchanging medium 6. These recesses from the housings can be distributed over the housing 3, in particular, uniformly over the surface of the outer wall of the cells 2. Alternatively, these can be formed in an interconnected manner, as shown in FIG. 1. i.e. the recess is formed as a contiguous cylinder jacket section, the recess being enlarged in the flow direction 2 for the cells 2 arranged one after the other. In this area, in which the heat-exchanging medium 6 covers the outer wall of the cells 2, the recess is formed as a coherent cylinder jacket section, a heat flow takes place from the warmer element, for example the cell 2, to the colder element, for example the medium 6. Usually, the cell 2 will have a higher temperature than the medium 6, so that a cooling of the cell 2 is caused, i.e. a warm flow from the cell 2 to the medium 6, in this case a cooling medium, takes place.

The area size of the heat exchange surface 4 is preferably determined in such a way that a temperature difference between the cells 2 is minimal at a given operating point and for given media flow parameters, in particular volume flow and media temperature at the inlet to the flow channel 5. Thus, it is an optimization problem under known boundary conditions. As a result, a corresponding heat exchange area distribution is obtained over the cells 2, which are flowed by the heat exchanging medium 6. Thus, the heat exchange area for each cell is determined in an optimized way. The housings 3 are adapted in the direction of flow S in such a way that the corresponding cell 2 each has a heat exchange area 4 that minimizes the temperature spread. The heat exchange areas 4 of the respective cells 2 then remain constant in size for the different operating points, but allow a minimum of a temperature difference or temperature spread of the cells 2 to be set by varying the volume flow.

Since the heat exchange surface 4 is determined by the housing 3, a cell 2 can also be replaced quickly without further ado. In this case, the minimization of the temperature spread is maintained without requiring any modification to the cell 2.

The first temperature sensor 7 is preferably positioned on the input side of the medium flow in the flow channel 5, preferably upstream of the first cell 2, which is irradiated by the medium 6. The second temperature sensor 8 is preferably arranged on the output side of the medium flow in the flow channel 5, in particular downstream of the last cell which is supplied with the medium 6. Temperature sensors 7 and 8 can include other functions, such as measuring the volume flow of the medium. Optionally, separate sensors, in particular in the flow channel, can also be provided for measuring the volume flow.

The cell currents of the cells 2, which are characteristic of the operating point of the energy store, can be fed to a control and/or regulating device 10. Likewise, the recorded measured values of the temperature sensors 7 and 8 and, if applicable, of the further sensors present can be fed to the control and/or regulating device 10.

The control and/or regulating device 10 has machine-readable program code 11, which allows a control intervention in the device for adjusting the volume flow 9, for example of a pump, of the heat-exchanging medium 6. The program code 11 is designed to adjust the volume flow of the medium 6 such that a temperature difference between the first cell in the flow direction and the last cell in the flow direction is reduced or minimal. This can be done via a controller or a controller. The program code 11 is stored in a non-volatile memory of the control and/or regulating device 10.

Furthermore, the program code 11 may be transferred to the control and/or regulating device 10 via a server or by means of a non-volatile storage medium.

Preferably, an actual volume flow of the medium 6 is detected via a sensor both for the control and for the control. In the case of the controller, this serves to verify the set volume flow present in the flow channel 5. In addition to the known conditions for the respective operating point of the cell, for example the cell current or a measure determined therefrom for the temperature of cell 2, to make a control intervention for the pump 9. The cell flow does not have to be measured; this can also be known from experience with regard to a certain power extraction of cell 2.

Depending on the current operating point of cells 2, an optimal volume flow rate for minimizing the temperature spread or the temperature difference is determined on the basis of a known characteristic curve field for the cell arrangement to be controlled. This is set by the control device 10 by means of the pump 9. The setting of the volume flow can be verified again via a volume flow sensor.

Since the operating point of the cells 2 can vary considerably within a short period of time depending on the power required or called up, the media temperature and the cell flow are preferably monitored continuously and the volume flow is adjusted accordingly, for example by regulating or controlling the process.

Furthermore, a determination of the temperature of at least the first and the last energized cell 2 in the direction of flow S can also be recorded or determined and, on the basis of the temperature difference, a regulation of the volume flow can be carried out by means of the control and/or regulating device 10 in such a way that the temperature difference between the cells 2 at the present operating point of the cells 2 becomes minimal.

FIG. 2 shows a 90° rotated view of the schematically illustrated energy storage heat exchanger system of FIG. 1. The reference signs of FIG. 2 have the same meaning as those of FIG. 1, as far as they are included in FIG. 2. From FIG. 2 in combination with FIG. 1 shows that the heat-exchanging medium 6 flows along the circumferential surfaces of the cells 2, but the front surfaces of the cells 2 are not surrounded by the heat-exchanging medium 6 in the control system and are thus available for sensors and energy supply and/or removal from the cells 2.

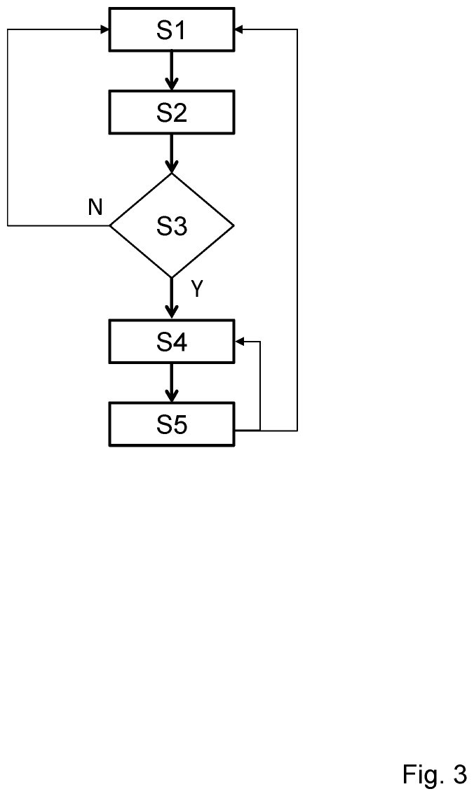

FIG. 3 shows a flow diagram for a method of operating an energy storage heat exchanger shown in FIG. 1 and FIG. 2. The diagram assumes that the energy storage heat exchanger is in operation and electrical energy is being drawn from the cells. This causes the cells to heat up. Cooling of the cells by means of a cooling medium, in that a heat-exchanging medium, in particular a cooling medium, flows around them as in FIGS. 1 and 2.

In a first method step S1 of measuring a temperature, a first temperature and a second temperature of the cooling medium are detected. The first temperature is measured upstream to the first cell, the second temperature is measured downstream to the last cell. These temperature values are fed to the control and/or regulating device.

In a second step S2 of the operating point determination process, the current operating point of the cells is checked and conditions characterizing the operating point are transmitted to the control and/or regulating device. If necessary, such a check of the operating point is carried out by the control and/or regulating device itself by communicating with a motor control or another control and requesting corresponding data, for example performance data.

In a third process step S3 of the check, the control and/or regulating device checks, on the basis of a characteristic curve field stored in the memory, whether the volume flow is suitable for the present parameters in the form of operating point and temperatures of the cooling medium. The characteristic diagram provides an optimum value for the volume flow for the corresponding parameters. If the flow rate for the cooling medium differs from the flow rate that leads to a minimum temperature difference between the first and last cell in the direction of flow, a control intervention takes place. In this case, the Y-path of the flow diagram is followed. If the set volume flow agrees with the value of the volume flow, at least within a predefined tolerance range, the characteristic curve field for the assigned parameters, no control intervention takes place. In this case, further continuous monitoring takes place until a control intervention is required. The N-path of the flow chart is followed.

In a fourth method step S4 of the control, the control and/or regulating device controls the device for adjusting the volume flow in such a way that the volume flow is increased or reduced to a volume flow predetermined, for example, from the characteristic curve field. This subsequently leads to the fact that the temperature difference of the first and last cell in the direction of current flow is reduced, thereby reducing or minimizing the temperature spread in its entirety between this first and last cell.

In an optional fifth step S5 of the test, the control and/or monitoring system checks control device whether the determined value of the volume flow from the characteristic curve field corresponds to the value currently present in the flow channel after the control intervention. If this is the case, the operating point and the temperatures of the medium are monitored again until the next control action. Otherwise, a further control intervention takes place until the desired value of the volumetric flow, which is obtained by changing the temperatures and/or the operating point is achieved in the cooling flow channel. In this case, the adjustment of the volume flow on the basis of a changed setpoint value of the volume flow due to changed media temperatures and/or change of the operating point enjoys priority over the tracking of an actual volume flow to an “outdated” value for the setpoint volume flow.

Since the devices and methods described in detail above are examples of embodiments, they may be modified to a wide extent by a person skilled in the art without departing from the scope of the invention. In particular, the mechanical arrangements and the proportions of the individual elements of the invention are described in detail and are to each other merely exemplary.

1. A method for operating a heat exchanger for an energy store, comprising the steps of:
arranging a plurality of electrochemical cells,
arranging a heat-exchanging medium configured for heat exchange flows around the cells one after the other in a flow direction,
wherein each of the cells comprises a heat exchange surface configured such that heat exchange between the heat-exchanging medium and a respective cell takes place,
wherein a first cell, in the flow direction, is configured to transfer heat via a first heat exchange surface with the heat-exchanging medium,
wherein a second cell is arranged downstream from the first cell by means of a second heat-exchanging surface that is larger than the first heat-exchanging surface, and
wherein a volume flow of the heat-exchanging medium is set such that, for a selected operating point of the cells, a temperature difference between a temperature of the first cell and a temperature of the second cells is at least one of reduced and minimized.

2. The method according to claim 1,
wherein the first cell in the flow direction and the last cell in the flow direction is used as the first cell and as the second cell.

3. The method according to claim 1, further comprising the steps of:
detecting a first temperature of the heat-exchanging medium at a first position,
detecting a second temperature at a second, downstream position, and
on the basis of conditions present at at least one of the determined operating point and the present cell flow, adjusting the volume flow such that a temperature difference of the cells is at least one of reduced and minimized.

4. The method according to claim 1, further comprising the steps detecting
a first temperature of a first cell in the direction of current flow and a second temperature of a second cell arranged downstream, wherein the volume flow is adjusted such that a difference between the first temperature and the second temperature decreases.

5. The method according to claim 1, further comprising the steps of controlling the volume flow and/or regulating the volume flow.

6. An energy storage heat exchange system, having an energy storage device, comprising:
a plurality of electrochemical cells configured to provide electrical energy, and having a flow channel for supplying the cells with a current of a heat-exchanging medium in the direction of flow,
wherein the cells are arranged one behind the other in the flow direction,
wherein the cells each have a heat exchange surface around which the heat-exchanging medium can flow and through which heat between the heat-exchanging medium and the cell is exchangeable,
wherein a first cell in the flow direction has a first heat exchange surface,
wherein a second cell arranged downstream of the first cell has a second heat exchange surface,
wherein the second heat exchange surface is larger than the first heat exchange surface, having a control and/or regulating device according to claim 6 and a device for adjusting the volume flow,
wherein the control and/or regulating device has the device for adjusting of the volume flow is operatively connected such that the volume flow can be controlled and/or regulated by the control and regulating device, in particular such that a temperature difference between a first temperature of the first cell and a temperature of the second cell is reduced, in particular minimized.

7. The energy storage heat exchange system according to claim 6, further comprising:
a first sensor configured to detect a temperature of the heat-exchanging medium and arranged at a first position of the flow channel, and
at least one second sensor configured to detect a temperature of the heat-exchanging medium,
and wherein temperature detected by the first and at least one second sensors is configured to be supplied by at least one of the control device and the regulating device.

8. The energy storage heat exchange system according to claim 6, wherein the heat-exchanging medium is configured to be guided in a flow circuit which is decoupled from a heat-exchanging circuit for controlling the temperature of a vehicle cabin or an engine.

9. The energy storage heat exchange system according to claim 6, further comprising a at least one of a control device and a regulating device configured to be operatively connected to a device for adjusting volume flow of a heat-exchanging medium.

10. The energy storage heat exchange system according to claim 9, wherein at least one of the control device and the regulating device is configured to regulate the energy storage heat exchange system, the heat exchange system comprising:
a heat exchanger configured to store energy store,
a plurality of electrochemical cells,
wherein the heat-exchanging medium is configured for heat exchange flows around the cells one after the other in a flow direction,
wherein each of the cells comprises a heat exchange surface configured such that heat exchange between the heat-exchanging medium and a respective cell takes place,
wherein a first cell, in the flow direction, is configured to transfer heat via a first heat exchange surface with the heat-exchanging medium,
wherein a second cell is arranged downstream from the first cell by means of a second heat-exchanging surface that is larger than the first heat-exchanging surface, and
wherein a volume flow of the heat-exchanging medium is set such that, for a selected operating point of the cells, a temperature difference between a temperature of the first cell and a temperature of the second cells is at least one of reduced and minimized.
